(19) United States
(12) Patent Application Publication
(10) Pub. No.: US 2006/0026050 A1
(43) Pub. Date: Feb. 2, 2006

(54) System and method for global delivery

(76) Inventors: Thomas J. Barth, Clinton, NJ (US); James C. Niemann, Addison, TX (US); Leann Case, McKinney, TX (US); Michael E. Fischer, Bloomfield Hills, MI (US); Pankaj K. Garg, Lombard, IL (US); Larry W. Miller, Davisburg, MI (US); Bhupendra N. Patel, Troy, MI (US); Daniel Zedorozny, Lucas, TX (US)

Correspondence Address: STEPHEN R. LOE, THE LAW OFFICE OF STEPHEN R. LOE, P.O. BOX 649, FRISCO, TX, 75034, US

(21) Appl. No.: 10/902,189

(22) Filed: Jul. 28, 2004

(51) Int. Cl. G06F 9/46

(52) U.S. Cl. 705/8

(57) ABSTRACT

A method, system, and computer program product for providing a service offering to an IT services provider client and managing the capabilities of the IT services provider is provided. In one embodiment a market is organized into market framework components. The resources of the IT services provider are organized into capability blocks each of which is associated with a respective market framework component. When a customer problem is received or determined, the customer problem is separated into customer market framework components. Capability block types that are associated with the customer market framework components are then determined and instances of available capability blocks types associated with the customer market framework components are grouped together to form a service offering which satisfies the customer problem.

### BACKGROUND OF THE INVENTION

1. Technical Field

The present invention relates generally to computer software and, more particularly, to software to aid in management and delivery of Information Technology Services.

2. Description of Related Art

As more companies operate on a global scale, the Information Technology (IT) industry needs to understand how to appropriately react and plan for a marketplace that envision small local or regional clients as well as large multi-national ones. Developing systems and methods for managing the business of delivering IT services on a global scale with global resources is a new, impending challenge for the IT services industry.

In the past, most IT services models depended on local or regional views to solve all issues associated with IT services delivery. Traditionally, the business model and systems employed to control the business of IT delivery were singled focused on one operating model and system for the business. A single tier model, while perhaps easier to envision, has serious short-comings in managing and controlling the complexity of business on a global basis.

The problem is no longer about how to structure the systems and methods to deliver to global clients, but how to create a global system and method to deliver to all clients, whether they are global clients or not. Therefore, it would be desirable to have a method, system, and computer program product that aids IT managers in managing IT products and services, determining where to expend resources, and determining what products, services and capabilities should be added to the assets of the IT service provider to better compete in the marketplace. Furthermore, it would be desirable to have a software product to aid salespeople in demonstrating to potential clients the services and options to configure delivery of available services for meeting the potential client's needs and inhibiting salespeople from offering a product or service to a potential client that the IT provider is currently unable to fulfill.

### SUMMARY OF THE INVENTION

The present invention provides a method, system, and computer program product for providing a service offering to an IT services provider client and managing the capabilities of the IT services provider. In one embodiment a market is organized into market framework components. The resources of the IT services provider are organized into capability blocks each of which is associated with a respective market framework component. When a customer problem is received or determined, the customer problem is separated into customer market framework components. Capability block types that are associated with the customer market framework components are then determined and instances of available capability blocks types associated with the customer market framework components are grouped together to form a service offering which satisfies the customer problem. By matching customer problem elements with capabilities provided by the IT service provider and available, a salesperson is prevented or inhibited in offering a service offering to a potential client that will obligate the IT services provider to actions the IT services provider is unable to perform. Furthermore, managers are able to inspect the utilization and allocation of capability blocks to determine which areas to expend additional resources and in which areas to reduce expenditures in order to better manage the total assets of the IT services provider and maximize or increase company revenues.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram illustrating a Global Delivery Model (GDM) 100 for defining, delivering and managing IT services in accordance with one embodiment of the present invention;

FIG. 2 depicts a pictorial representation of a distributed data processing system in which the present invention may be implemented;

FIG. 3 depicts a block diagram of a data processing system which may be implemented as a server in accordance with the present invention;

FIG. 4 depicts a block diagram of a data processing system in which the present invention may be implemented; and

FIG. 5 depicts an exemplary process flow and program function for global delivery and management of IT services in accordance with one embodiment of the present invention.

### DETAILED DESCRIPTION OF THE PREFERRED EMBODIMENT

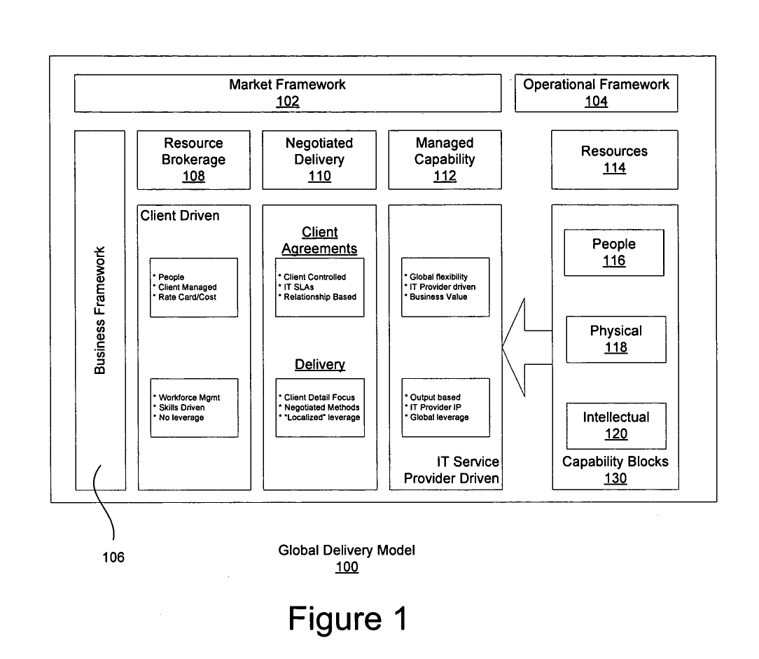

With reference now to the figures and, in particular, with reference to FIG. 1, a block diagram illustrating a Global Delivery Model (GDM) 100 concept is depicted in accordance with one embodiment of the present invention. The GDM 100 System & Method is designed to enable an Information Technology (IT) services company to manage the breadth of the business associated with both regional and global delivery of various types of products and services. Products and services will be managed based on the GDM 100 System and Method to align the appropriate products and services with the appropriate method for delivering that particular piece of client demand.

The Global Delivery Model System & Method has success formulas associated with each piece of client demand serviced by an IT services provider, such as, for example, Resource Brokerage 108, Negotiated Delivery 110, and Managed Capability 112. These success formulas, when blended together using the GDM 100, create a unified, but decomposable, view of all elements (e.g., Resource Brokerage 108, Negotiated Delivery 110, Managed Capability 112, and Resources 114, such as, for example, people, 116, physical resources 118, and intellectual resources 120) of the IT services provider's service delivery to that client. These same success formulas, sliced by market framework 102 or overall client demand, provide a method for IT services providers to separately view and evaluate the various elements of their business.

Any customer or management identified problem or request is classified into one of the three blocks of resource brokerage 108, negotiated delivery 110, and managed capability 112 associated with a market framework 102. However, these classification blocks 108-112 may be broken up into elements corresponding to a business framework 106 as well. An example of resource brokerage 108 is staff augmentation and an example of managed capability 112 is managing rendering of bills. Negotiated Delivery 110 is typically where IT outsourcing occurs. The GDM manages the available resources 114 (which are broken up into capability blocks 130 comprising people 116, physical 118, and intellectual 120 assets) in the operation framework 104 of the IT services provider and matches these resources 114 and capabilities with customer or management problems or requests to create implementable solutions.

Thus, the blending and management of the success formulas in GDM provide IT service providers a business relevant system and method for gaining visibility into the business of providing IT services. Thereby allowing IT service provider managers with the knowledge to more efficiently allocate or develop resources to maximize revenues for the IT service provider. Furthermore, an IT service provider's salesperson in the field may determine which services and products are available for offering to a potential customer through the use of the GDM 100. This prevents a salesperson from inadvertently closing a deal with a customer that requires the IT services provider to perform functions or duties that it is not equipped to provide, either because resources are stretched too thin or because a particular service has not been implemented by the IT services provider. Thus, the IT services provider is not obligated to expend valuable resources and money in performing a bad contract, thereby saving money for the IT services provider.

In addition, the GDM 100 allows a salesperson to offer several different packages of products and services to a potential customer and enable the salesperson to articulate the various advantages to each package to the customer, thereby providing the customer with greater value. Furthermore, the customer may be alerted to potential savings that the customer had not previously thought of. The GDM method and system of the present invention will be described in more detail below.

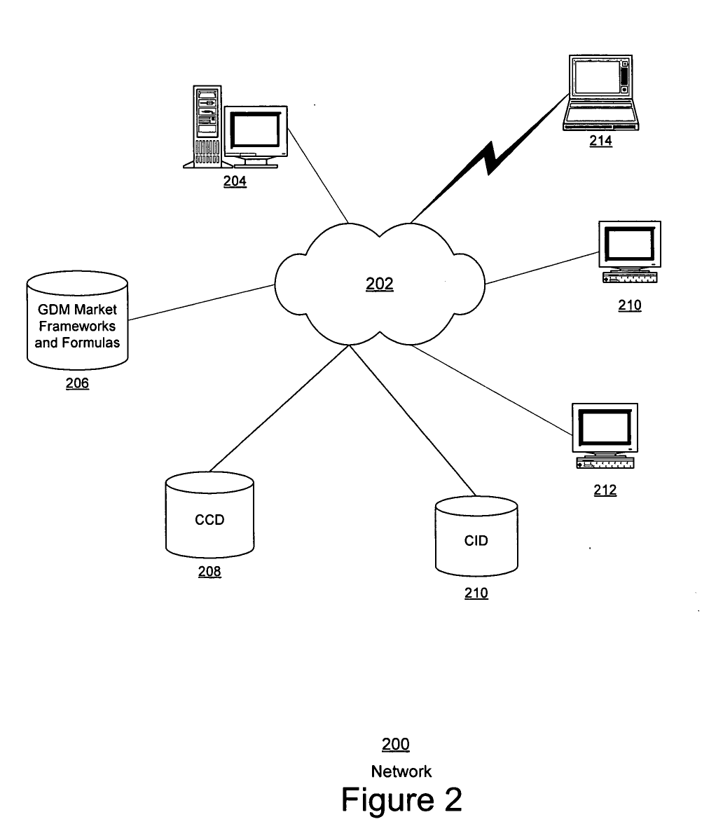

Referring now to FIG. 2, a pictorial representation of a distributed data processing system is depicted in which the present invention may be implemented.

Distributed data processing system 200 is a network of computers in which the present invention may be implemented. Distributed data processing system 200 contains network 202, which is the medium used to provide communications links between various devices and computers connected within distributed data processing system 200. Network 202 may include permanent connections, such as wire or fiber optic cables, or temporary connections made through telephone connections, and may include both wired and wireless communications.

In the depicted example, server 204 is connected to network 202, along with storage units 206-210. In addition, clients 210, 212, and 214 are also connected to network 202. These clients, 210, 212, and 214, may be, for example, personal computers or laptop computers. In the depicted example, server 204 provides access to the GDM system to the various clients 210-214. Clients 208, 210 and 212 are clients to server 204. Distributed data processing system 200 may include additional servers, clients, and other devices not shown.

Storage unit 206 contains the GDM market frameworks and formulas that the IT services provider has determined best represent various markets, such as, for example, the automotive industry, the telecommunications industry, and the insurance industry. Each of these industries may have various IT services requirements which may differ from each other and these requirements, frameworks in which the IT services provider and the customer must work, as well as formulas that apply to the industry or customer have been identified by the IT services provider through experience.

Storage unit 208 contains a Capability Control Database (CCD) which identifies which capability blocks may fit together to provider a service offering and which block may not be fit together to provider a service offering. A service offering is created by grouping capabilities together. A capability block is a group of people utilizing IT services provider physical and intellectual property assets that produce a certain kind of output. The CCD 208 includes attributes and formulas about the capability blocks, such as, for example, the identity of each capability block, where it is physically located, and performance attributes. Performance attributes may include such items as experience level, pedigrees (e.g., degrees held by members of the block), and past performance evaluations. The location of the capability block may be important because certain kinds of activities may require physical interaction between the members of the capability block and a customer or the actions to be performed by the capability block require physical proximity to a customer's assets.

Storage unit 210 contains a Capability Instance Database (CID). CID 210 contains the identity of each group within the IT services provider that forms a capability block of a given type. Thus, the IT services provider may have several groups that each form a capability block providing the same output as each other, however, possibly having differing levels of experience and quality, as well as possibly being geographically dispersed. Thus, different instances of a capability block may have different quality, experience, and geographic attributes. The CID 210 also keeps track of which instances of a capability block are currently available to be grouped into a new service offering and which are currently engaged in other activities or will be engaged in other activities at the relevant time making them unavailable to meet the demands of a customer offering.

The GDM running on server 204 tracks the identity and utilization of capability blocks, where they are used and how they are utilized, as well as when the capability blocks are available and when they are not available. Furthermore, the GDM tracks customer requests and how these requests match up with existing IT services provider capabilities as well as how often a potential customer enters into a contract with the IT services provider. The GDM also provides that when a customer problem from a potential customer is identified and corresponds to a market framework component for which the IT services provider does not have a matching capability, then an alert may be sent to a manager thereby alerting the manager that the IT services provider may be missing out on valuable opportunities because certain capabilities are not offered by the IT services provider. Thus, the manager may decide to implement new capabilities in order to capture these lost opportunities if it is deemed to be cost effective and profitable.

Server 204 provides an interface to managers and salespersons allowing them to use the GDM. For example, a salesperson meeting with a client may log into the system using laptop computer 214 via a wireless connection. Upon learning of the potential customer's problems and requirements, the salesperson may enter this data into the interface. The GDM then accesses the various databases 206-210 to formulate potential service offerings that will satisfy the customer's problems and requirements. Because the GDM is able to determine what IT service provider capabilities are available, the GDM prevents the salesperson from offering a service agreement that the IT service provider is unable to perform. The GDM may provide a single service offering to the salesperson for presentation to the potential customer or may provide several service offerings to the salesperson. The differing service offerings may present the potential customer with tradeoffs between cost, efficiency, and quality and allow the salesperson to show the potential client how various alternatives may affect the customer. For example, a customer may desire a particular level of service, but when confronted with the cost and shown the cost of a lesser level of service, may decide that the tradeoff in service is worth the cost. However, another customer may be unwilling to make such a tradeoff.

IT services provider managers may also tap into the GDM through server 204 to aid in determining how to best improve the revenues of the IT services provider. For example, the GDM may show the manager that a particular type of capability block is heavily utilized and under represented. Thus, the manager may decide to expend additional resources of time and/or money in developing more capability blocks of that type. The manager may also notice that several potential customers desire a capability not currently offered by the IT services provider. Therefore, in such a case, the manager may decide to expend resources in developing new types of capability blocks. Alternatively, other capability blocks may be underutilized. Therefore, the manager may decide to eliminate capability blocks or reallocate their resources so as to create a different type of capability block.

In the depicted example, distributed data processing system 200 is the Internet, with network 202 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 200 also may be implemented as a number of different types of networks such as, for example, an intranet or a local area network.

FIG. 2 is intended as an example and not as an architectural limitation for the processes of the present invention.

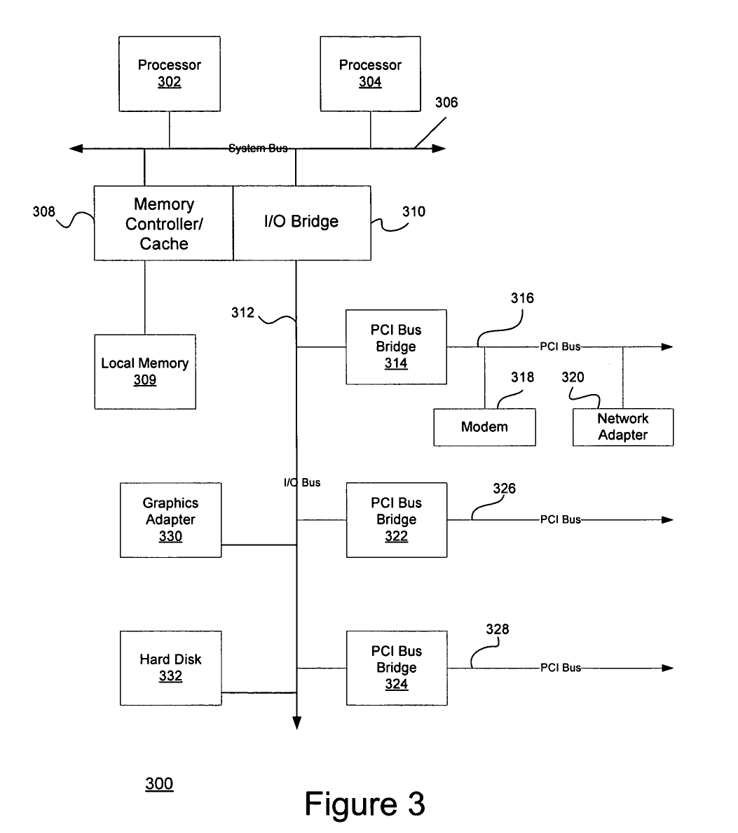

Referring to FIG. 3, a block diagram of a data processing system which may be implemented as a server, such as server 104 in FIG. 1, is depicted in accordance with the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems 318-320 may be connected to PCI bus 316. Typical PCI bus implementations will support four PCI expansion slots or add-in connectors. Communications links to network computers 210-214 in FIG. 2 may be provided through modem 318 and network adapter 320 connected to PCI local bus 316 through add-in boards. Modem 318 may be connected to or incorporate a wireless device to allow for wireless communications, such as, for example, as depicted with laptop 214 in FIG. 2.

Additional PCI bus bridges 322 and 324 provide interfaces for additional PCI buses 326 and 328, from which additional modems or network adapters may be supported. In this manner, server 300 allows connections to multiple network computers. A memory mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

Data processing system 300 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

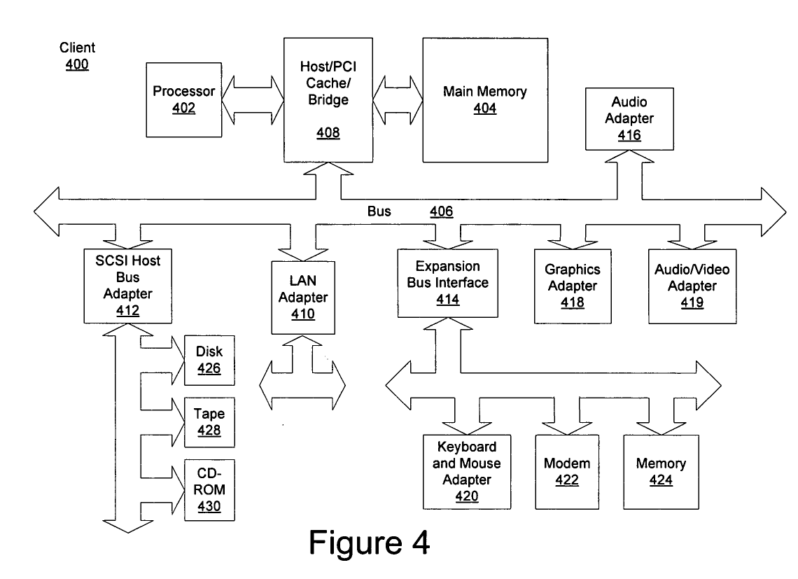

With reference now to FIG. 4, a block diagram of a data processing system in which the present invention may be implemented is illustrated. Data processing system 400 is an example of a client computer. Data processing system 400 employs a peripheral component interconnect (PCI) local bus architecture. Although the depicted example employs a PCI bus, other bus architectures, such as Micro Channel and ISA, may be used. Processor 402 and main memory 404 are connected to PCI local bus 406 through PCI bridge 408. PCI bridge 408 may also include an integrated memory controller and cache memory for processor 402. Additional connections to PCI local bus 406 may be made through direct component interconnection or through add-in boards. In the depicted example, local area network (LAN) adapter 410, SCSI host bus adapter 412, and expansion bus interface 414 are connected to PCI local bus 406 by direct component connection. In contrast, audio adapter 416, graphics adapter 418, and audio/video adapter (A/V) 419 are connected to PCI local bus 406 by add-in boards inserted into expansion slots. Expansion bus interface 414 provides a connection for a keyboard and mouse adapter 420, modem 422, and additional memory 424. In the depicted example, SCSI host bus adapter 412 provides a connection for hard disk drive 426, tape drive 428, CD-ROM drive 430, and digital video disc read only memory drive (DVD-ROM) 432. Typical PCI local bus implementations will support three or four PCI expansion slots or add-in connectors.

An operating system runs on processor 402 and is used to coordinate and provide control of various components within data processing system 400 in FIG. 4. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 400. Instructions for the operating system, the object-oriented operating system, and applications or programs are located on a storage device, such as hard disk drive 426, and may be loaded into main memory 404 for execution by processor 402.

Those of ordinary skill in the art will appreciate that the hardware in FIG. 4 may vary depending on the implementation. For example, other peripheral devices, such as optical disk drives and the like, may be used in addition to or in place of the hardware depicted in FIG. 4. The depicted example is not meant to imply architectural limitations with respect to the present invention. For example, the processes of the present invention may be applied to multiprocessor data processing systems.

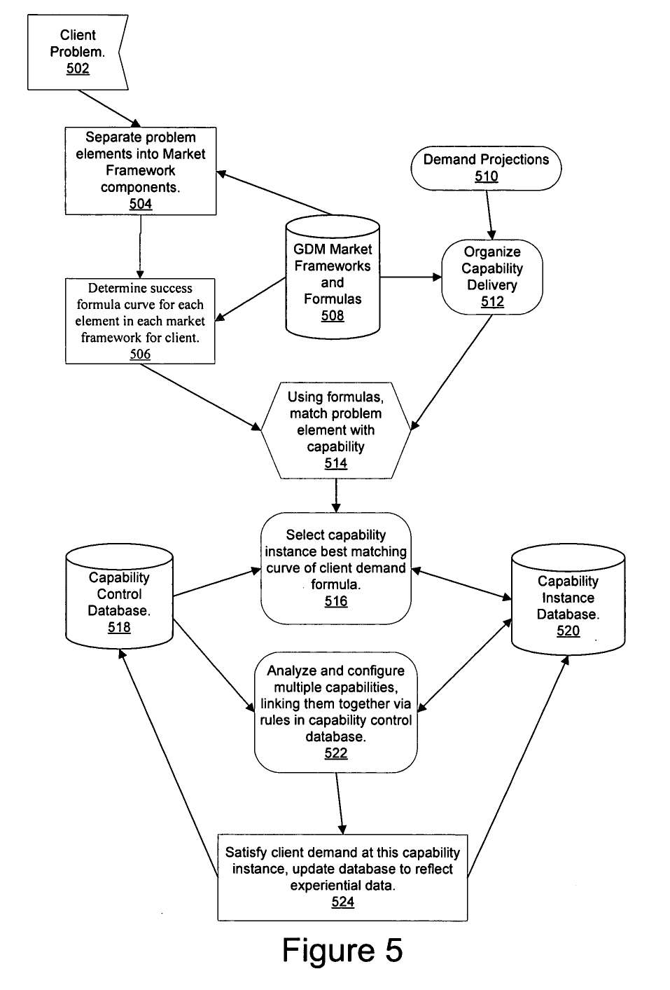

With reference now to FIG. 5, an exemplary process flow and program function for global delivery and management of IT services is depicted in accordance with one embodiment of the present invention. The process and program function depicted in FIG. 5 may be implemented on, for example, server 204 depicted in FIG. 2.

From the client side, a client problem 502 is identified and the problem elements are separated into market framework components (step 504) utilizing frameworks and formulas identified previously and stored in database 508 or, alternatively, using the experience of the salesperson or other IT services provider representative. Using the data from database 508, the system determines the success formula curve for each element in each market framework for the client (step 506). Using formulas from database 508, problem elements are then matched with capabilities (step 514). These capabilities have been organized (step 512) through matching of demand projections 510 with market frameworks and formulas from database 508.

Once the problem elements are matched with capabilities, then the GDM selects a capability instance best matching the curve of a client demand formula utilizing the rules and data from a capability control database 518 as well as the identities and attributes of various instances of capability blocks from capability instance database 520 (step 516). Next, the GDM analyzes and configures multiple capabilities linking them together via rules in the capability control database 518 and the availability of capability instances from capability instance database 520 (step 522). Next, if the client enters into a service agreement with the IT services provider, then the client demand is satisfied at this capability instance and the databases 518-520 are updated to reflect the experiential data.

Although the present invention has been described primarily with reference to an Information Technology Industry, those skilled in the art will recognize that the present invention may apply to a broader spectrum of service oriented businesses. Therefore, the present invention is not limited in application to the Information Technology Industry.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for providing a service offering, the method comprising:
organizing a market into market framework components;
organizing resources into capability blocks and associating the capability blocks with market framework components;
receiving a customer problem;
separating the customer problem into customer market framework components;
identifying capability block types that are associated with the customer market framework components; and
selecting available capability block instances to form a service offering which satisfies the customer problem.

2. The method as recited in claim 1, wherein selecting available capability block instances comprises consulting rules outlining which capability block instances are compatible and the service offering only from capability block instances which are mutually compatible.

3. The method as recited in claim 2, wherein the rules outlining which capability block instances are compatible are contained in a capability control database.

4. The method as recited in claim 1, further comprising:
updating a database with data indicating which capability block instances are being utilized, the duration of the utilization for each capability block instance, and other data and formulas related to the utilization of the capability block instances.

5. The method as recited in claim 4, wherein other data related to the utilization of the capability block instance comprises at least one of the identity of the customer and the nature of the customer's industry.

6. The method as recited in claim 1, further comprising:
responsive to a determination that at least one of the customer market framework components does not correspond to an existing capability block instance provided by the information technology service provider, alerting a user.

7. A computer program product in a computer readable media for use in a data processing system for providing a service offering, the computer program product comprising:
first instructions for receiving market framework components for a market;
second instructions for organizing resources into capability blocks and associating the capability blocks with market framework components;
third instructions for receiving a customer problem;
fourth instructions for separating the customer problem into customer market framework components;
fifth instructions for identifying capability block types that are associated with the customer market framework components; and
sixth instructions for selecting available capability block instances to form a service offering which satisfies the customer problem.

8. The computer program product as recited in claim 7, wherein selecting available capability block instances comprises consulting rules outlining which capability block instances are compatible and delivering the service offering only from capability block instances which are mutually compatible.

9. The computer program product as recited in claim 8, wherein the rules outlining which capability block instances are compatible are contained in a capability control database.

10. The computer program product as recited in claim 7, further comprising:
seventh instructions for updating a database with data indicating which capability block instances are being utilized, the duration of the utilization for each capability block instance, and other data and formulas related to the utilization of the capability block instances.

11. The computer program product as recited in claim 10, wherein other data related to the utilization of the capability block instance comprises at least one of the identity of the customer and the nature of the customer's industry.

12. The computer program product as recited in claim 7, further comprising:
seventh instructions, responsive to a determination that at least one of the customer market framework components does not correspond to an existing capability block instance provided by the information technology service provider, for alerting a user.

13. A system for providing a service offering, the system comprising:
first means for receiving market framework components for a market;
second means for organizing resources into capability blocks and associating the capability blocks with market framework components;
third means for receiving a customer problem;
fourth means for separating the customer problem into customer market framework components;
fifth means for identifying capability block types that are associated with the customer market framework components; and
sixth means for selecting available capability block instances to form a service offering which satisfies the customer problem.

14. The system as recited in claim 13, wherein selecting available capability block instances comprises consulting rules outlining which capability block instances are compatible and the service offering only from capability block instances which are mutually compatible.

15. The system as recited in claim 14, wherein the rules outlining which capability block instances are compatible are contained in a capability control database.

16. The system as recited in claim 13, further comprising:
seventh means for updating a database with data indicating which capability block instances are being utilized, the duration of the utilization for each capability block instance, and other data and formulas related to the utilization of the capability block instances.

17. The system as recited in claim 16, wherein other data related to the utilization of the capability block instance comprises at least one of the identity of the customer and the nature of the customer's industry.

18. The system as recited in claim 13, further comprising:
seventh means, responsive to a determination that at least one of the customer market framework components does not correspond to an existing capability block instance provided by the information technology service provider, for alerting a user.
